(19) United States
(12) Patent Application Publication
(10) Pub. No.: US 2008/0107095 A1
(43) Pub. Date: May 8, 2008

(54) METHOD AND APPARATUS FOR A COMMUNICATION SYSTEM OPERATING IN A LICENSED RF AND AN UNLICENSED RF BAND

(75) Inventors: GREG R. BLACK, VERNON HILLS, IL (US); CHARLES P. BINZEL, BRISTOL, WI (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 11/972,109

(22) Filed: Jan. 10, 2008

Related U.S. Application Data
(63) Continuation of application No. 10/750,277, filed on Dec. 31, 2003.

(51) Int. Cl. H04B 7/216; H04B 17/00; H04B 1/713

(52) U.S. Cl. 370/342; 455/67.11; 375/132

(57) ABSTRACT

The present invention relates generally to wireless communications, and more particularly to a communication system operating in a licensed RF band and an unlicensed RF band. The method comprises exchanging (302) traffic information (410) between a base station (102) and a mobile station (105, 107) on at least one radio channel in the unlicensed RF band (402) and exchanging (304) control information (405) that is associated with the traffic information, in the licensed radio frequency band (404).

### FIELD OF THE INVENTION

The present invention relates generally to wireless communications, and more particularly to a communication system operating in a licensed RF band and an unlicensed RF band.

### BACKGROUND OF THE INVENTION

Wireless communication devices generally operate in either licensed radio frequency (RF) bands or unlicensed RF bands. Radiotelephone service providers generally acquire licenses to operate a wireless communication system in one or more of a plurality of licensed RF bands. These systems employ multiple methods to allow multiple access by multiple mobile stations on a common band of frequency channels. These systems generally operate in licensed RF bands. Other systems operate in unlicensed RF bands. Systems that operate in licensed RF bands have control over the frequencies and channels and how they are operated on. This allows the operator to ensure reliability of data, and in particular, control information used to control traffic communicated with devices in communication therewith. Systems operating in unlicensed RF band do not have this control and data transmission error occur as a result of uncoordinated transmissions.

One access technique, frequency division multiple access (FDMA), allows multiple access by assigning the mobile stations to different frequency channels within the RF band. Some of these systems employ frequency hopping, wherein data is transmitted to and from the intended mobile station while periodically changing the frequency channel. The periodic channel frequency hopping occurs on a regular time interval known as a frame. Coordinated frequency hopping systems use predetermined hopping patterns, or hop-sets, wherein the hop-sets are coordinated between all mobile stations to ensure that the signals to and from two or more mobile stations do not occur simultaneously on the same frequency channel. Uncoordinated frequency hopping does not coordinate the hop-set between mobile stations resulting in the periodic occurrence of simultaneous signal transmission on the same frequency. Such simultaneous transmissions are referred to as channel collisions. Data reception errors occurring during a channel collision are referred to as data collisions. Uncoordinated frequency hopping within this type of system is generally not used as the channel collisions and resultant data collisions will occur. The FCC has prohibited coordinated frequency hopping within the Industrial Scientific and Medical (ISM) bands in order to avoid spectrum aggregation by a single type of service.

Systems such as Bluetooth and 802.11 wireless communication systems, for example operate within the ISM bands. To avoid data collisions these systems may monitor the band and choose to operate only in unoccupied sub-bands. These systems may also change sub-bands as the result of the detection of interferer signal strength or the detection of signaling errors indicative of a channel collision with another transmitting station. However channel collisions still occur as devices must sense the interference caused by a channel collision in order to change the frequency sub-band.

Therefore, what is needed is a method for a communication system to operate in a licensed RF band and an unlicensed RF band.

### BRIEF DESCRIPTION OF THE DRAWINGS

The various aspects, features and advantages of the present invention will become more fully apparent to those having ordinary skill in the art upon careful consideration of the following Detailed Description of the Drawings with the accompanying drawings described below.

FIG. 1 is an exemplary diagram of a communication system;

FIG. 2 is an exemplary block diagram of a wireless communication device;

FIG. 3 is an exemplary flow diagram of a data transmission method;

FIG. 4 is an exemplary frequency and time slot map;

FIG. 5 is an exemplary frequency and time slot map;

FIG. 6 is an exemplary flow diagram of a data transmission method;

FIG. 7 is an exemplary flow diagram of a data transmission method;

FIG. 8 is an exemplary flow diagram of a data transmission method; and

FIG. 9 is an exemplary flow diagram of a data transmission method.

### DETAILED DESCRIPTION OF THE DRAWINGS

A method for a communication system to operating in a licensed radio frequency (RF) band and an unlicensed RF band is disclosed. The method comprises communicating with mobile stations in both a licensed RF band and an unlicensed RF band. The base station communicates control information to the mobile station in the licensed RF spectrum. Traffic channels established between the base station and the mobiles reside in the unlicensed spectrum. The method also comprises determining that a first data set, which is to be sent to a first device, and a second data set, which is to be sent to a second device, are scheduled to be transmitted in the unlicensed RF band simultaneously on a first frequency, i.e. a channel collision. The data collision is avoided between the two data sets, by transmitting the first data set on the first frequency hopping frequency, while the second data set is delayed, also known as muted. The first data set is thereby transmitted unambiguously and data collisions are avoided in the first device. The final step is transmitting the second data set on a second frequency hopping frequency, sequentially next in the frequency hop pattern at the next frame.

The second data set is thereby transmitted unambiguously with a delay of at least one frame. Thus the hopping channels are uncoordinated, since the original uncoordinated hopping sequences are unmodified except for the muting of the transmission to the second device during the channel collision. Data collisions are avoided in the second device during the transmission of the first data set by a determination that the second device is not the intended recipient, and suspension of data reception until another frame.

The base station communicates control information with the mobile station in the licensed RF spectrum in one exemplary embodiment. In another exemplary embodiment, the base station communicates using code division multiple access or wideband code division multiple access techniques in the licensed RF band and uncoordinated frequency hopping patterns in the unlicensed RF band.

Due to RF spectrum limitations, an increase in users and the cost of RF spectrum licenses, wireless telecommunications service providers could benefit from using unlicensed RF spectrum to compliment the licensed spectrum portion of their systems. Although the spectrum is unlicensed, use-requirements still apply. FCC requirements for transmission in the industrial, scientific and medical (ISM) bands, for instance, requires that transmissions use uncoordinated frequency hopping with power limitations.

One example is the use of unlicensed RF bands to augment GSM radiotelephone services. The GSM system uses non-hopping channel frequencies with high transmission power for broadcast control channels, which are unsuitable for transmission in the ISM bands. For other control channels and traffic channels the GSM system uses coordinated frequency hopping in which each mobile station uses the same set of channel frequencies and hopping pattern, and a unique time offset of the hopping pattern determined by the mobile allocation index offset (MAIO). In this way the system can accommodate one communication signal for each hopping channel without the occurrence of channel collisions.

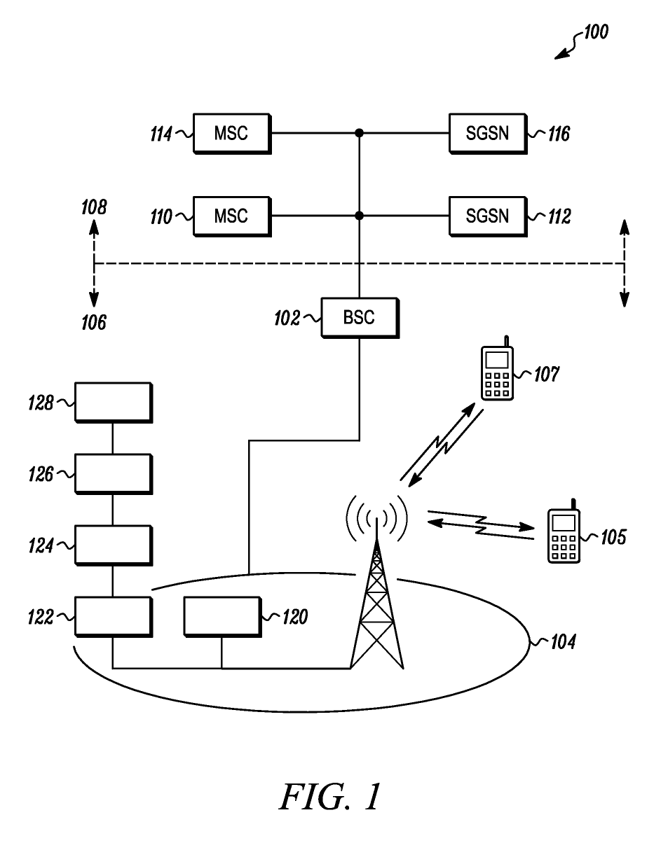

FIG. 1 is an exemplary diagram of a wireless communication system 100 according to the present invention. The system 100 includes a base station controller (BCS) 102, also known as a radio network controller (RNC) 102 in some systems, at least one base station 104, and a first wireless device 105, also known as a mobile station (MS) 105, and a second wireless device 107. The BCS 102 and the base stations 104 form the radio access network (RAN) 106 portion of the system which communicates with the wireless devices. A core network, which is coupled to the RAN, includes a mobile switching center (MSC) and may include a serving GPRS support node (SGSN). The core network (CN) 108 portion of the system, illustrated in FIG. 1, includes a first MSC 110 and a first SGSN 112 for a first service provider. The system 100 may also include a second MSC 114 and a second SGSN 116 for a second service provider. In the exemplary embodiment shown in FIG. 1, only two core networks are illustrated but it is understood by one skilled in the art that a plurality of core networks may be coupled to a RAN.

The base station 104 receives messages from the BCS 102 and transmits the messages to the intended wireless devices under an uncoordinated frequency hopping scheme. Communications between the base station 104 and the first wireless device 105 share a first uncoordinated hop-set while the base station 104 and the second wireless device 107 share a second uncoordinated hop-set while. There is no coordination between the first uncoordinated hop-set and the second uncoordinated hop-set, however these hop-sets may comprise common frequency channels such that frequency channel collisions may occur. The wireless devices may be mobile stations or other user equipment that communicate with a serving node, such as the exemplary base station 104 of the communication system 100 in FIG. 1. Each wireless device however is coordinated with the base station 104 to necessarily form the communication link between the two. Information represented in the data sets which are to be transmitted to the wireless devices either originate at the BCS 102, or are received at the BCS 102 from the core network to be relayed to the intended wireless device. The information can be either packet-switched data or circuit-switched data and the information may be voice information or data information.

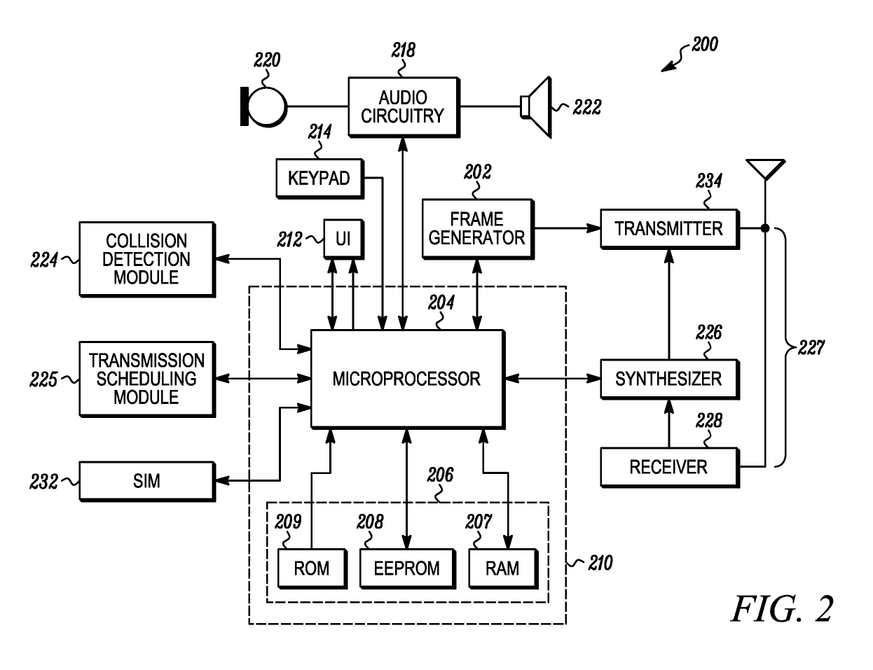

Turning to FIG. 2, a block diagram of a wireless communication device 200, a mobile station in one embodiment, in accordance with the preferred embodiment of the invention is shown. This embodiment may be a cellular radiotelephone incorporating the present invention. However, it is to be understood that the present invention is not limited to the embodiment and may be utilized by other wireless communication devices such as paging devices, personal digital assistants, portable computing devices, and the like, having wireless communication capabilities. In this embodiment a frame generator 202 and a microprocessor 204, combine to generate the necessary communication protocol for operating in a wireless communication system. Microprocessor 204 uses memory 206 comprising RAM 207, EEPROM 208, and ROM 209, which may be consolidated in one package 210, to execute the steps necessary to generate the protocol and to perform other functions for the wireless communication device, such as writing to a display 212, accepting information from a keypad 214, or controlling a frequency synthesizer 226 and DSP 116 to attune the device to the appropriate frequency in a frequency hopping pattern. The memory may also include a SIM card 232. In situations where the wireless device is used for voice transmissions, the frame generator 202 processes audio transformed by audio circuitry 218 from a microphone 220 and to a speaker 222.

FIG. 2 also shows at least one transceiver 227 comprising receiver circuitry 228, that is capable of receiving RF signals from at least one bandwidth and optionally more bandwidths. The receiver 228 may optionally comprise a first receiver and a second receiver, or one receiver capable of receiving in two or more bandwidths. For example one band is an unlicensed RF band and another band is a licensed RF band. The receiver 228, depending on the mode of operation, may be tuned to receive PLMRS, AMPS, GSM, EGPRS, CDMA, UMTS, WCDMA, Bluetooth, WLAN, such as 802.11 communication signals for example. The transceiver 227 includes at least one transmitter 234. The at least one transmitter 234 may be capable of transmitting to one device or base station in one frequency band and second frequency band. For example, the transmitter transmits traffic information over a first channel in the unlicensed RF band, and control information associated with the traffic information over the second channel in the licensed RF band. As with the receiver 228, dual transmitters 234 may optionally be employed where one transmitter is for the transmission to a proximate device or direct link establishment to WLAN's and the other transmitter is for transmission to the base station 108.

The mobile station also includes a message scheduling module, that schedules traffic information to be sent in the unlicensed RF band and that schedules control information which is associated with the traffic information to sent in the licensed RF band.

The wireless communication device 200 of the present invention can be adapted to communicate in a frequency hopping wireless communication may also comprise a channel collision detection module 224 that detects when received messages are not intended to be received by the mobile station and a transmission scheduling module 225 both coupled to the microprocessor 204.

A base station 104 of the wireless communication system may include a transmitter 120 and a receiver 122 for communicating with a plurality of wireless communication devices. The base station 104 would also include a message reception module 124, that receives messages from the core network which are to be transmitted to one of a plurality of wireless communication devices. The base station may also include a frequency hop pattern generation module 126. The frequency hop pattern generation module 126 determines the frequency hop-set pattern for each device of the plurality of devices. The frequency hop-set patterns are uncoordinated from device to device. The base station 104 also includes a channel collision detection module 128 that detects when received messages are scheduled to be transmitted on the same frequency at the same time and a message scheduling module that reschedules or delays transmission of a data set that was determined to collide with another data set.

The base station 104 communicates control information with the wireless device on control channels which are transmitted within the licensed RF spectrum. In one exemplary embodiment, the base station 104 is a GSM communication system. The base station 104 will identify that the wireless device 105 can communicate in both the licensed and unlicensed RF spectrum, also known as RF band. The network will then assign at least one traffic channel in the unlicensed RF spectrum using the control channels in the licensed RF band.

In the exemplary embodiment, GSM multi-frame types I-IV contain the control channels used for general link maintenance. These control channels are not mapped to a channel in the unlicensed radio frequency band. The GSM multi-frame types V and VI, contain traffic channels (TCH's) and at least two control channel that are associated with the traffic channels, the slow associated control channel (SACCH) and the fast associated control channel (FACCH). The TCH portions are candidates for transmission in the unlicensed RF band. However, the SACCH and the FACCH are mapped to at least one channel in the licensed RF band. The licensed RF band will provide greater reliability for these control channels. The unlicensed RF band is susceptible to greater interference as there is less or no regulation. The TCH therefore can be assigned to a channel in the unlicensed RF band while the control channels associated with the particular control channel are assigned to a channel in the licensed RF band to maintain reliable control over the respectively associated TCH.

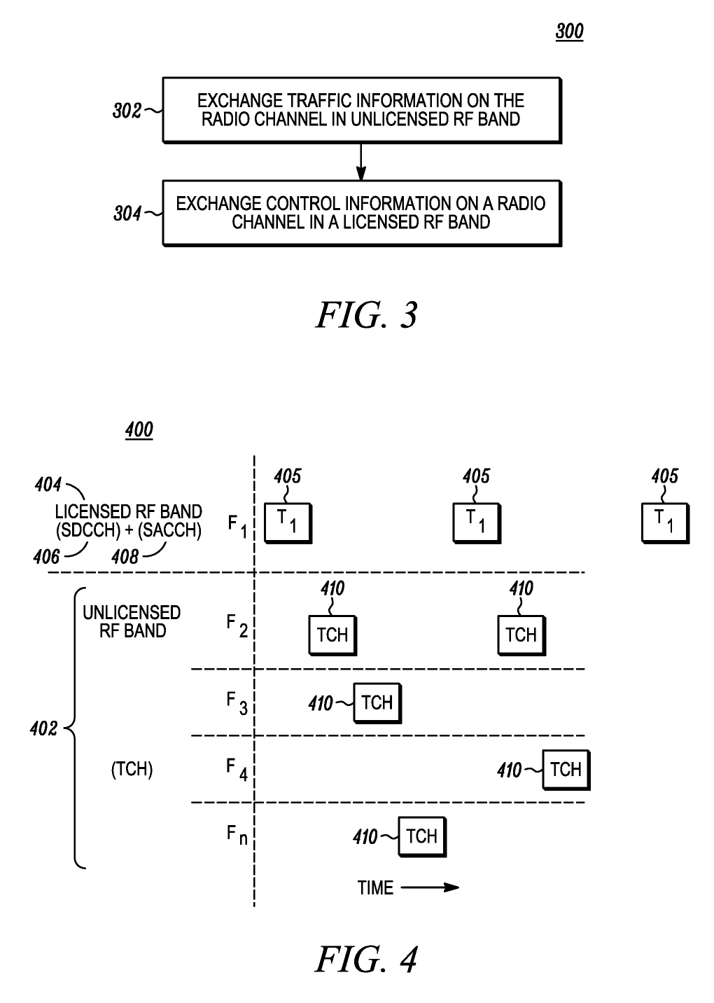

In one exemplary embodiment, shown in FIG. 3, a method in a communication system which operates in a licensed RF band and an unlicensed RF band comprises exchanging 302 traffic information between the base station 102 and a mobile station 105 on at least one radio channel in the unlicensed RF band. The method further comprises exchanging 304 control information that is associated with the traffic information, in the licensed radio frequency band.

In one exemplary embodiment, shown in FIG. 4, the mobile station 105 is exchanging traffic information on a traffic channel (TCH), which is transmitted on a frequency hopping channel pattern including channel F2, F3 and F4 which are all in the unlicensed RF band 402. The control information 405 that is associated with the traffic information is exchanged on a dedicated channel (T1) on a frequency in the licensed RF band 404. In one exemplary embodiment, the GSM system for example, the dedicated channel in the licensed RF band includes a stand alone dedicated control channel (SDCCH) 406 and a slow associated control channel (SACCH) 408.

In this exemplary embodiment, SDCCH is used to more reliably send and receive on a licensed channel frequency the data normally sent with the TCH on the SACCH and FACCH. The SDCCH is sometimes referred to as a as ⅛ rate traffic or TCH/8. Each half rate traffic channel, i.e. TCH/2, which is moved to a channel in the unlicensed RF band requires one new TCH/8 to be added on the licensed RF band.

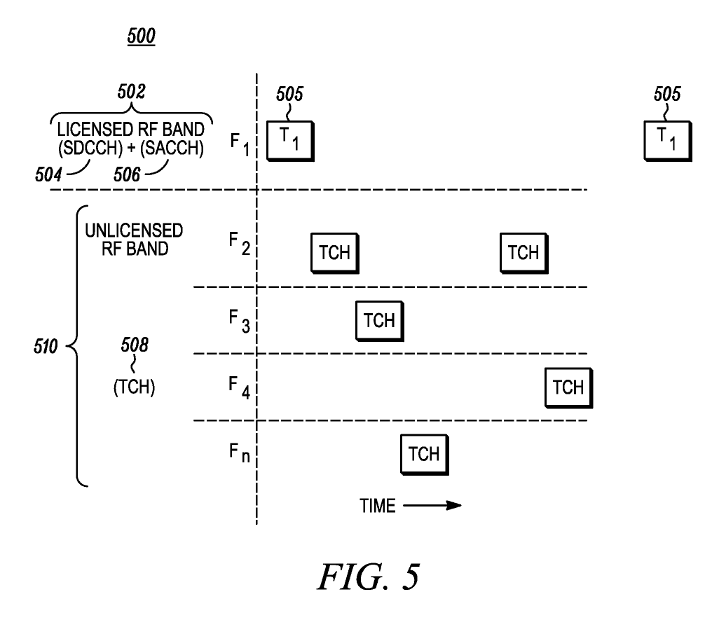

In another exemplary embodiment, shown in FIG. 5, the control information 505 is exchanged on a first control channel in the licensed RF band 502, the first control channel includes a second control channel which is dedicated to a first mobile station of a plurality of mobile stations and a third control channel, which is shared between the plurality of mobile stations. For example, a channel in the licensed RF band includes the slow associated control channel (SACCH) 504 and an on-demand fast associated control channel (DFACCH) 506. The SACCH 504 may be dedicated to a first mobile station of a plurality of mobile stations and the DFACCH 506 is shared between the plurality of mobile stations. When a mobile station needs to use the DFACCH 506, for a base station handoff for example, a request for use of the shared DFACCH 506 by the mobile station is transmitted on the SACCH 504. In the exemplary embodiment, the request for the use of the DFACCH between the plurality of mobile stations is by a use field or a grant field encoded on a dedicated SACCH.

In this embodiment, the TCH 508 is mapped to the unlicensed RF band and the SACCH 504 is mapped on the channel in the licensed RF band 502. In lieu of the FACCH it provides a new SACCH/DFACCH multi-frame type, mapped onto a licensed channel frequency. In this exemplary embodiment, the new SACCH/DFACCH supports 18 unlicensed traffic channels with SACCH messaging at the usual rate (480 ms/4 block message), and one on-demand FACCH (DFACCH) shared by the 18 users on an as-needed basis. One bit is used on uplink SACCH (all blocks) for FACCH request, and one bit is used in the down link SACCH for a grant of the FACCH. If the Network needs to perform a handover, it sets the bit in the SACCH of the specific mobile station, and then transmits starting in the next FACCH. When the mobile station needs to use the FACCH to contact the BS, it requests the FACCH by setting the request bit and then monitoring the grant bit. Whenever the grant bit is set in the SACCH the mobile station starts to monitor the DFACCH.

In the above exemplary embodiments, the channel conditions are communicated from the mobile station by transmitting traffic channel conditions of at least one traffic channel in the unlicensed RF band over an uplink control channel in the licensed RF band. Control channel conditions are communicated by transmitting control channel conditions of at least one control channel in the licensed RF band over a control channel in the licensed RF band. Other control channel conditions may be transmitted in the licensed RF band over a control channel which is also in the licensed RF band. The mobile station will receive control information over a downlink control channel in the licensed RF band, wherein the control information is related to the traffic information in the unlicensed RF band.

The control information that may be communicated or exchanged over the licensed RF band is handoff information, an end call message, a neighbor list, a neighbor report, a power control message, a timing control message or the like. In one exemplary embodiment, portions of the dedicated channel are used for traffic information when control information is not being sent.

It is understood by one skilled in the art that the present invention may apply to communications systems that operate under the GSM standard but also under EDGE, CDMA, WCDMA, TDMA UMTS, and any communication system that operates in both a licensed and an unlicensed RF band. For example traffic channel in the system be a CDMA channel. The control channel may also be a CDMA channel. The CDMA traffic channel may be in the unlicensed RF band while the CDMA control channels are in the licensed RF band. In another exemplary embodiment, the unlicensed band requires a frequency hopping pattern to be used for channelization, such as is required by the FCC for operation in the ISM band for example.

In yet another exemplary embodiment, the traffic channel (TCH) is a plurality of frequencies of a frequency hopping pattern. In this exemplary embodiment, the frequency hopping pattern is uncoordinated and in the unlicensed RF band.

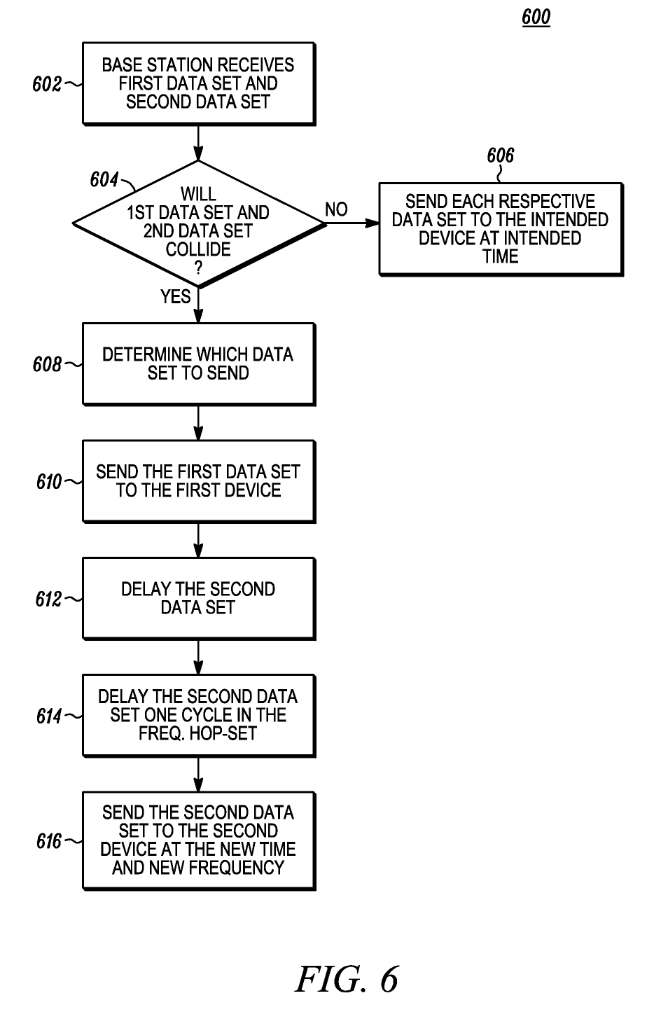

FIG. 6 shows an exemplary flow diagram 600 illustrating how a first data set is received 302 at the base station 104 for transmission to the intended mobile station. The intended mobile station can be the first wireless device 105 in this exemplary embodiment. In step 602, the first data set is received at a first time on a first frequency of a first uncoordinated frequency hop-set. Similarly, a second data set is also received at the base station 104 for transmission to the intended mobile station, the second mobile station 107 in this exemplary embodiment. The first data set and the second data set do not necessarily arrive at the base station 104 at the same time. It is envisioned that they will in fact be received independently. The second data set can be also scheduled to be sent at the first time on the first frequency of a second uncoordinated frequency hop-set. The base station 104 can determines in step 604 that a data collision will occur as both the first and the second data set are scheduled to be transmitted on the same frequency at the same time. In step 608, the base station 104 can determine which data set to send first or at all. In step 610, the first data set is then transmitted to the first wireless device 105 in this exemplary embodiment. This provides for an unambiguous transmission to the first wireless device 105. In step 612, the second data set is delayed, or muted, and not transmitted at the scheduled time or on the scheduled frequency. If the second data set is to be delayed, in step 614, the second data set may be delayed one or more frames, or time periods of the hop-set. In step 616, the second data set can then be sent to the second device 107, at the delayed time on the next scheduled frequency of the hop-set. If the base station 104, in step 604 determines that a collision will not occur, the base station 104 transmits 606 both data sets as scheduled in accordance with each respective hop-set.

Although two data sets are used for exemplary purposes throughout this disclosure, it is envisioned that a plurality of data sets may be scheduled to be transmitted simultaneously and on the same frequency as the individual frequency hop-sets associated with each device are uncoordinated between the devices. As the number of wireless devices communicating in the communication system increases, the potential for data collisions also increases. Therefore the base station 104 must check the scheduling of all messages, in accordance with the above method, to be transmitted to avoid collisions.

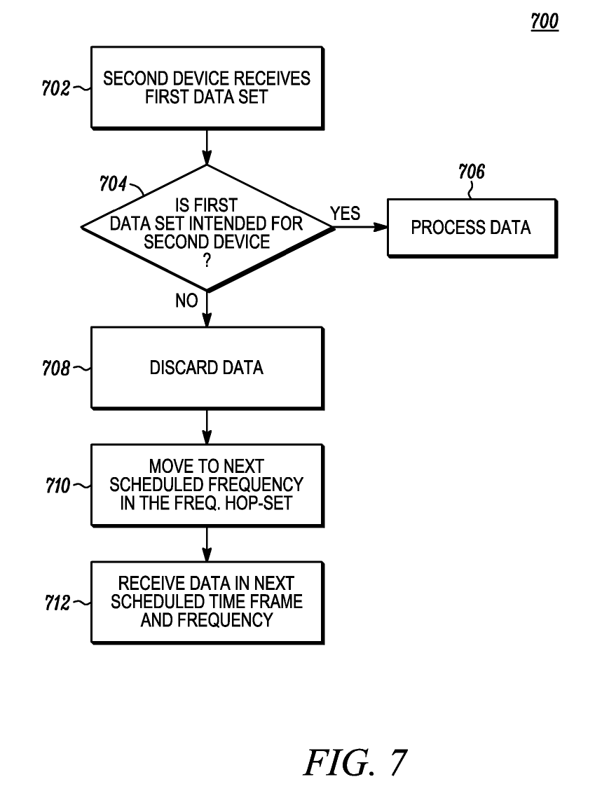

Referring now to the exemplary flowchart in FIG. 7, which outlines the operation according to an exemplary embodiment. For example, the second wireless device 107 is the intended recipient of the second data set from the base station 104. As the base station 104 has delayed 612 the transmission of the second data set, the second device 107 can receive 702 the first data set during the scheduled time the second device 107 is supposed to receive the second data set. The second device 107 is not the intended recipient of the first data set. The second wireless device 107 determines 704 that it is not the intended recipient for the data transmitted, i.e. the first data set, by the base station and the first data set is discarded 708 or reception suspended.

Continuing with reference to FIG. 7, the second device 107 tunes 710 to the next scheduled frequency in the hop pattern allowing that device to receive 712 the second data set at the next frequency, at the next scheduled frame. The next frequency in the hopping pattern is the next scheduled frequency in the hop-set, such that the hopping pattern resumes at the next scheduled frame. In this way the two hopping patterns, a first hopping pattern for the first device 105 and a second hopping pattern for the second device 107, are uncoordinated hopping patterns since the hopping patterns are unaltered after the occurrence of a channel collision.

The base station 104 should determine which data set should be transmitted after determining 604 that a channel collision will occur. In one exemplary embodiment, the base station 104 or the base station controller 102, will send the data set received first in time at the base station 104 or the base station controller 102. In this exemplary embodiment, the data sets are processed on a first in first out (FIFO) basis. In another exemplary embodiment, the data set to be sent first is randomly selected. If multiple data sets are scheduled to collide, all except one data set would have to be rescheduled. It should be noted that multiple transmissions can occur at the same time, however multiple transmission can not occur at the same time on the same frequency without causing data collisions and resultant data errors in the wireless device receivers. In yet another embodiment, priority is given according to the needs of the wireless device, whereby voice data may be given higher priority than other types of data, for example. It is understood by one skilled in the art that there are a plurality of methods for determining which data set to send and in what order, and the disclosure is not limited to those exemplary embodiments listed herein.

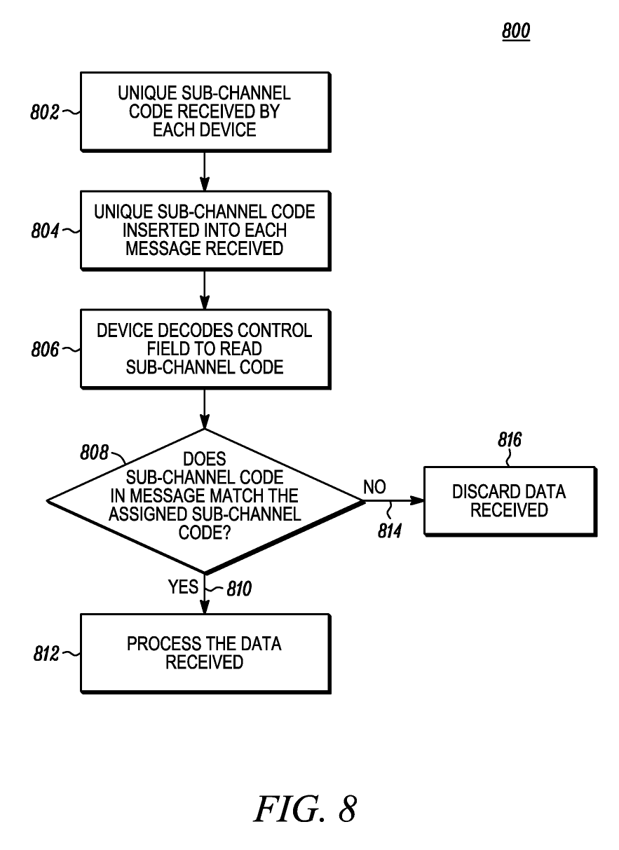

Moving to FIG. 8, is an exemplary flowchart outlining a method 800 for determining that the data is not intended to be received by either of the exemplary first wireless device 105 or the second wireless device 107. For Example, this method may be used in step 704 of flowchart 700. In this embodiment, shown in FIG. 8, a unique sub-channel code may be assigned 802 to each wireless device using the hop-set. The unique sub-channel code may be inserted 804 into each received. In this exemplary embodiment, the unique sub-channel code may be included in a control field in the received data set. The unique sub-channel code allows each device to determine which data set, the first data set or the second data set in the exemplary embodiment, is intended to be received by the respective device. The wireless device 105, 107 may then decode 806 the control field upon reception of the data set and determine 808 if the unique sub-channel code in the received data set matches the unique sub-channel code assigned to the wireless device by the base station 104. If the unique sub-channel code matches 810, then the device processes 812 the data. If the unique sub-channel code does not match 814, the data set is discarded 816.

For example, in an exemplary GSM system, a GSM traffic channel (TCH) might be modified to include a temporary mobile station identity code (TMSIC), which is the unique sub-channel code having a unique value for every wireless device receiving a data set, i.e. data transmissions, from the base station on a particular hop-set of hopping frequencies channels. Upon decoding the TMSIC the second mobile station will determine that the received TMSIC is different that it's TMSIC assignment and discard the received data or suspend reception.

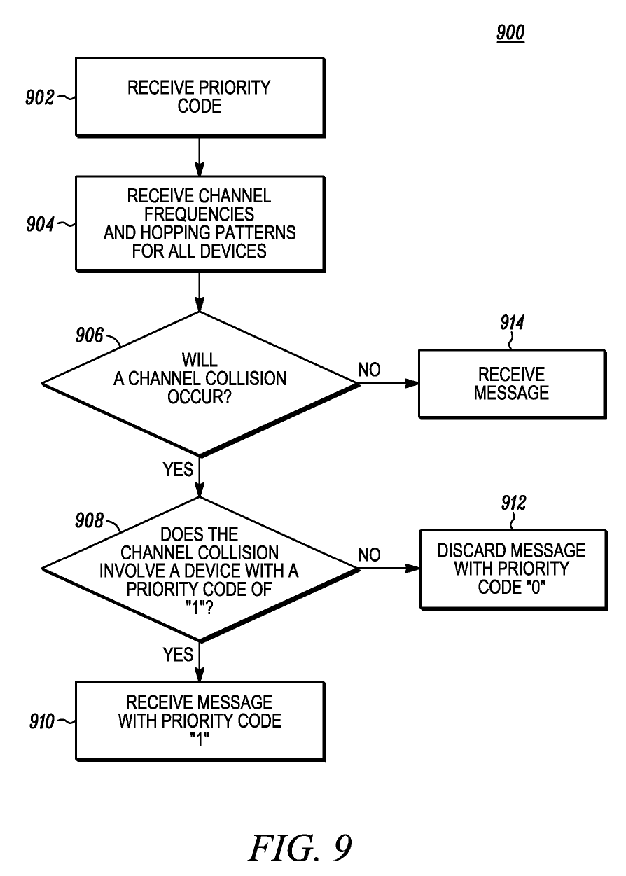

Referring to FIG. 9, in another exemplary embodiment flowchart 600, the wireless devices, such as the first and second wireless devices 105, 107, receive 902 from the base station a unique priority code which is assigned to each wireless device using the hop-set of frequency hopping channels. The wireless device, 105, 107 then receive 904 from the base station 104 the channel frequencies and hopping patterns of all wireless devices using a hop-set. The received frequencies and hopping patterns are used by the wireless devices 105, 107 to predict channel collisions. For example when the first wireless device 105 may detect 906 a channel collision, the first device uses a predetermined rule set to determine 908 the intended recipient of the information transmitted by the base station 104. The predetermined rule set assures that only one recipient is assigned during a channel collision. In one exemplary embodiment of this approach, the first wireless device 105 is assigned a device priority of “1”, and a device priority of “0” is assigned to all other wireless devices using the hop-set. Once the base station detects 906 that the channel collision will occur, the base station must determine 908 if the channel collision involves data being sent to at least one device with a higher priority code. The base station will determine if a first message has a priority code higher than a second message. In this exemplary embodiment, only the first wireless device with the priority of “1” will receive the transmission of the first message when a channel collision occurs. The base station will send 610 the first message which has the higher priority code and delay 612 the message or messages with the lower priority code. In this embodiment, multiple devices can be given the priority of “1” and when a channel collision is detected, the rule set determines which device with the “1” priority to receive the data set, with all other data set transmissions being delayed until the next scheduled frame. In another exemplary embodiment the device priority might automatically change according to predetermined rules after each channel collision, such that the mobile stations alternate using the channel during channel collisions. Upon determining that a channel collision will occur and that the transmitted data set is intended for a different wireless device, the second mobile station suspends reception.

In the above exemplary embodiments, the methods allow for the avoidance of data collisions in the downlink transmissions on the traffic channels from base station to mobile station, i.e. wireless device. Analogous techniques may be applied for avoiding data collisions on the uplink transmissions, i.e. transmissions between mobile stations and the base station. This applies to the situation in which the uplink and down-link hop sets are uncoordinated. However it is anticipated that coordination of up-link and down-link hop-sets will be allowed. In the cases such where the downlink and uplink channels are assigned in pairs, one exemplary embodiment provides a method where the uplink channel assignment follows the downlink assignment on the same frequency channels. In another exemplary embodiment, such as in the GSM case, the uplink channel follows the downlink channel with a fixed frequency offset. According to this approach, whenever a downlink channel collision occurs there will necessarily be a corresponding uplink collision. Thus, in this exemplary embodiment, when a wireless device receives a downlink data set during a channel collision as in accordance with one of the approaches described above, it will then transmit its uplink data set on the scheduled uplink transmission period, whereas if a wireless device does not receive a data set during a channel collision it will refrain from transmitting its data set on the scheduled uplink period, and wait until the next scheduled uplink period to transmit the data set on the next channel frequency in the hop-set, thereby avoiding an uplink data collision.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a communication system operating in a licensed radio frequency band and an unlicensed radio frequency band comprising:
exchanging traffic information between a base station and a mobile station on at least one radio channel in the unlicensed radio frequency band; and
exchanging control information that is associated with the traffic information, in the licensed radio frequency band.

2. The method according to claim 1, wherein exchanging traffic information further comprises exchanging traffic information on a traffic channel in the unlicensed radio frequency band.

3. The method according to claim 2, wherein the traffic channel includes a plurality of frequencies of a frequency hopping pattern.

4. The method according to claim 2, wherein the traffic channel is a code division multiple access channel.

5. The method according to claim 2, wherein the traffic channel is a wideband code division multiple access channel.

6. The method according to claim 2, wherein the control information that is associated with the traffic information is exchanged on a dedicated channel in the licensed radio frequency band.

7. The method according to claim 6, wherein the dedicated channel in the licensed radio frequency band includes a stand alone dedicated control channel and a slow associated control channel.

8. The method according to claim 2, wherein a channel in the licensed radio frequency band includes a slow associated control channel and an on-demand fast associated control channel.

9. The method according to claim 8, wherein the slow associated control channel is dedicated to a first mobile station of a plurality of mobile stations and
wherein the on-demand fast associated control channel is shared between the plurality of mobile stations.

10. The method according to claim 1, wherein the control information is exchanged on a first control channel in the licensed radio frequency band, the first control channel including a second control channel that is dedicated to a first mobile station of a plurality of mobile stations and a third control channel that is shared between the plurality of mobile stations.

11. The method of claim 1, further comprising transmitting traffic channel conditions of at least one traffic channel in the unlicensed radio frequency band over an uplink control channel in the licensed radio frequency band.

12. The method according to claim 1, further comprising transmitting control channel conditions of at least one control channel in the licensed radio frequency band over a control channel in the licensed radio frequency band.

13. The method according to claim 10, transmitting control channel conditions of at least one control channel in the licensed radio frequency band over a control channel in the licensed radio frequency band.

14. The method according to claim 10, further comprising receiving control information over a downlink control channel, wherein the control information is related to the traffic information in the unlicensed radio frequency band.

15. The method according to claim 3, further comprising transmitting a frequency hopping pattern of all mobile stations communicating with the communication system on a control channel in the licensed radio frequency band.

16. The method according to claim 1, wherein the control information exchanged over the licensed radio frequency band is handoff information.

17. The method according to claim 1, wherein the control information exchanged over the licensed radio frequency band is an end call message.

18. The method according to claim 1, wherein the control information exchanged over the licensed radio frequency band is a neighbor list.

19. The method according to claim 1, wherein the control information exchanged over the licensed radio frequency band is a neighbor report.

20. The method according to claim 1, wherein the control information exchanged over the licensed radio frequency band is a power control message.

21. The method according to claim 1, wherein the control information exchanged over the licensed radio frequency band is a timing control message.

22. The method according to claim 7, wherein portions of the dedicated control channel are used for traffic when control information is not being sent.

23. A wireless communication device operating in a licensed radio frequency band and simultaneously in an unlicensed radio frequency band comprising:
a message scheduling module, that schedules traffic information to be sent in the unlicensed radio frequency band and that schedules control information which is associated with the traffic information to sent in the licensed radio frequency band; and
a transmitter that transmits traffic information over a first channel in the unlicensed radio frequency band, and transmits control information associated with the traffic information over the second channel in the licensed radio frequency band.

24. A method in a base station operative in a licensed radio frequency band and an unlicensed radio frequency band, said method of comprising:
transmitting traffic information from a base station on at least one radio channel in the unlicensed radio frequency band; and
transmitting control information that is associated with the traffic information, in the licensed radio frequency band.

25. The method according to claim 24, further comprising:
receiving traffic information from a base station on at least one radio channel in the unlicensed radio frequency band; and
receiving control information that is associated with the traffic information, in the licensed radio frequency band.

26. A method in a mobile station operative in a licensed radio frequency band and an unlicensed radio frequency band, said method comprising:
receiving traffic information from a base station on at least one radio channel in the unlicensed radio frequency band; and
receiving control information that is associated with the traffic information, in the licensed radio frequency band.
